(19) United States
(12) Patent Application Publication
(10) Pub. No.: US 2008/0267268 A1
(43) Pub. Date: Oct. 30, 2008

(54) Method of Converting a Digital Bb (Baseband) Signal Into an Analog (Intermediate-Frequency) Signal

(76) Inventor: Andreas Bury, Dresden (DE)

Correspondence Address: NXP, B.V.;NXP INTELLECTUAL PROPERTY DEPARTMENT, M/S41-SJ, 1109 MCKAY DRIVE, SAN JOSE, CA, 95131, US

(21) Appl. No.: 11/632,030

(22) PCT Filed: Jul. 5, 2005
(86) PCT No.: PCT/IB05/52234

§ 371 Date: Aug. 14, 2007

(30) Foreign Application Priority Data
Jul. 8, 2004 (EP) 04103243.4

(51) Int. Cl. H04L 25/00

(52) U.S. Cl. 375/216

(57) ABSTRACT

The invention relates to a method of converting a digital BB (baseband) signal into an analog IF (intermediate-frequency) signal, wherein the digital BB processor signal is oversampled K times by means of a BB/IF converter, and each i^{th} channel of the K channels is subsequently selected by means of a controllable i^{th} digital interpolation filter comprised in the BB/IF converter and controllable in K steps and is shifted into the i^{th} frequency position in the spectrum of the analog IF signal. The object of the invention to create standardized compensations in a practicable manner in W-LAN units for a distortion of the frequency response which occurs during signal processing and is caused by the effects of the gap function (si) during D/A conversion and by the use of the transmission method and the mode of modulation is achieved in that the frequency response of the digital BB processor signal is realized without pre-emphasis. Subsequent to the BB/IF converter supplying the uncompensated digital IF signal and prior to the D/A converter converting the signal into the analog IF signal, a digital compensation filter corrects the frequency response for the analog IF signal by pre-emphasis of the compensated digital IF signal.

The invention relates to a method of converting a digital BB (baseband) signal into an analog IF (intermediate-frequency) signal, wherein the digital BB processor signal is oversampled K times (K=number of channels) by means of a BB/IF converter, and each i^{th} channel of the K channels is subsequently selected by means of a controllable i^{th} digital interpolation filter comprised in the BB/IF converter and controllable in K steps and is shifted into the i^{th} frequency position in the spectrum of the analog IF signal, the frequency response of the D/A converter supplying the analog IF signal being corrected by pre-emphasis of the digital BB processor signal.

In the state of the art, the communicators in a wireless network such as embodied, for example, by Access Point or W-LAN (Wireless Local Area Network) clients, are often preferably realized by W-LAN units. These W-LAN units used, for example, as extension cards for a personal computer (PC), PC cards of a notebook, etc. consist of at least two parts.

In a first part, viz. the BB/IF unit, the digital BB signal is first generated by means of a signal processor.

In the state of the art, this signal is provided as a separate real part and a separate imaginary part by the signal processor and is subsequently also separately processed up to the analog IF signal.

The digital complex sampling values of each digital BB signal are provided in the BB/IF converter for a number K of channels, such that each K channel is arranged in the spectrum of the IF signal by means of frequency shifts in accordance with the standard to be used. Each K band is selected by means of an interpolation filter.

The IF signal thus comprises the number K of channels which are available in a complex signal form.

This complex, digital IF signal processed in a separate real part and a separate imaginary part is converted into an analog IF transmission signal in the respective D/A converters (D/A-U) which have been assigned to the real part and the imaginary part and are operated at a high sampling frequency.

Since the digital signal values are represented by discrete voltage and current values, outputted in time-discrete steps, the analog output signal is generated in stages.

Signal-analytically, these output signals can be interpreted as a sequence of square-wave unit pulse responses of the D/A-U and thus as a square-wave sampling of the digital IF signal.

This means that the output signal is superimposed with a gap function (si) in its frequency variation and is thus distorted.

The output signal of the respective D/A-U is applied as a real part or as an imaginary part of the IF input signal to the input of the radio-frequency (RF) unit which represents a second part of the W-LAN unit. In this second part of the W-LAN unit, the IF signal is formed in an analog way via a further smoothing bandpass filter, smoothed and processed in such a way that it is modulated with the RF transmission signal. The RF transmission signal is now supplied from the output of the RF unit for the purpose of transmission via an antenna.

A great drawback of the prior-art solutions is that a very elaborate operation, performed separately for the real part and the imaginary part, must take place in the BB/IF converter.

It is another drawback that, additionally, a large number of components must be used for filtering and smoothing the complex IF signal. The (si) distortion (attenuation characteristic in accordance with the gap function) occurring at the output of the D/A converter due to, for example, pre-emphasis of the digital BB signal or post-equalization of the analog IF signal in an analog bandpass filter can only be realized to a very incomplete extent.

It is therefore an object of the invention to create standardized compensations in a practicable manner in W-LAN units for a distortion of the frequency response which occurs during signal processing and is caused by the effects of the gap function (si) during D/A conversion and by the use of the transmission method and the mode of modulation.

According to the invention, the object is achieved in that the frequency response of the digital BB processor signal is realized without pre-emphasis. Subsequent to the BB/IF converter supplying the uncompensated digital IF signal and prior to the D/A converter converting the signal into the analog IF signal, a digital compensation filter corrects the frequency response for the analog IF signal by pre-emphasis of the compensated digital IF signal.

This solution aims at a direct frequency response correction by a digital compensation filter between the BB/IF converter supplying the digital IF signal and the D/A converter converting the signal into the analog IF signal, which correction is performed directly in that this filter superimposes a compensatory pre-emphasis in a dedicated manner on the frequency response of the IF transmission signal, independently of other digital processing steps.

An embodiment of the invention is characterized in that the compensated digital IF signal is pre-emphasized in such a way that the filter characteristic of the digital compensation filter is formed complementarily to the frequency response of the D/A converter caused by the gap function (si).

This solution utilizes the fact that, relative to the digital IF signal, only a small portion of the spectrum (usually less than 25%) can be considered as the useful spectrum. It is only in this frequency range that also the (si) variation is compensated.

A further embodiment of the invention is characterized in that the compensated digital IF signal is pre-emphasized in such a way that the filter characteristic of the digital compensation filter is formed additionally complementarily to the frequency response caused by the transmission method used and the mode of modulation as well as by its parameter.

This solution has for its object that specific distortions, which are only caused by the used transmission methods and modes of modulation, can also be specifically compensated. A high modulation accuracy is thereby also achieved.

A variant of the method according to the invention is characterized in that the digital compensation filter is formed as a FIR filter, preferably with 1 to 5 delay elements.

This solution makes it advantageously clear that a digital filtering operation can be performed with few components and at low cost.

A further variant of the method according to the invention is characterized in that the digital compensation filter is preferably formed with binary weighted filter coefficients.

In this variant, the selection of filter coefficients adapted to the binary format of the values yields a small bit length and a satisfactory binary processing of the coefficients.

These and other aspects of the invention are apparent from and will be elucidated with reference to the embodiments described hereinafter.

In the drawings:

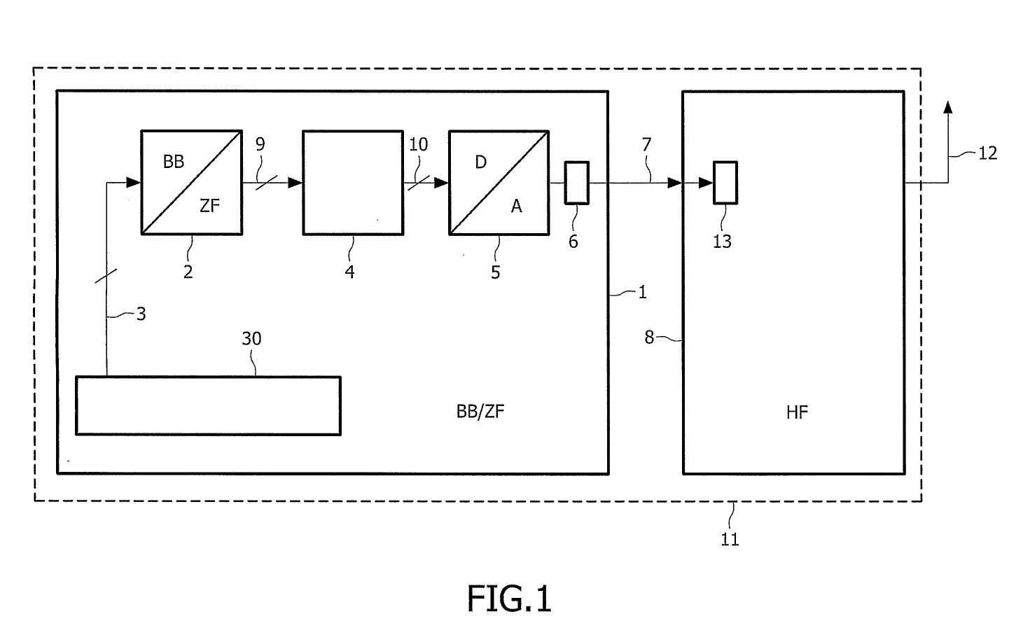

FIG. 1 is a block diagram of the W-LAN unit (11)

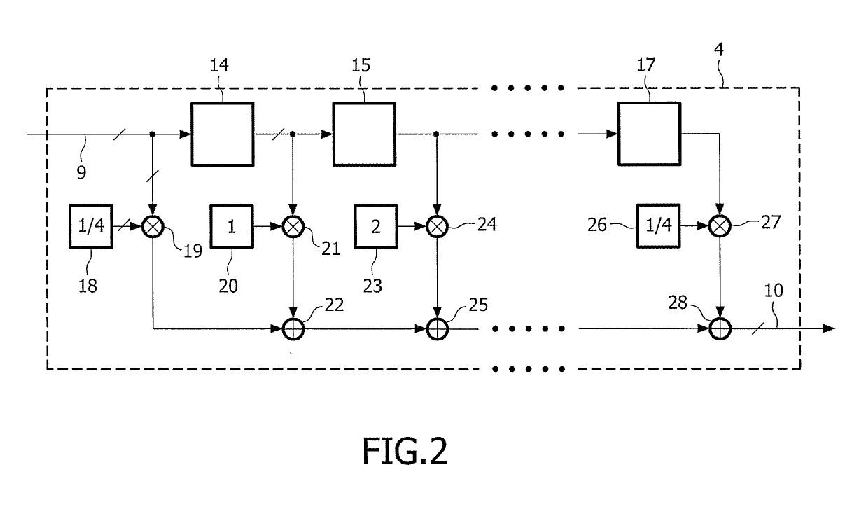

FIG. 2 is a block diagram of the digital compensation filter (4)

FIG. 1 shows that the digital BB processor signal 3 is generated in the baseband processor 30 and applied to the input of the BB/IF converter 2. Its output supplies the uncompensated digital IF signal 9 to the digital compensation filter 4.

In this filter, a dedicated pre-emphasis is performed so that the compensated digital IF signal 10 for the D/A converter 5 is generated at its output. The D/A converter 5 converts the compensated digital IF signal 10, smoothed by means of the first smoothing bandpass filter 6, into the analog IF signal 7. The BB/IF unit 1 supplies this analog IF signal 7 to the RF transmission unit 8.

In the RF transmission unit 8, it is smoothed by means of a second smoothing bandpass filter 13, mixed with a radio frequency, and the signal is supplied from its output to the antenna 12.

FIG. 2 shows that the filter coefficients determining the filter characteristic of the digital compensation filter 4 are stored in first, second, third and further coefficient memories 18, 20, 23, and 26, respectively.

In a first state, the instantaneously current value of the uncompensated digital IF signal 9 applied to the input of the digital compensation filter 4 is provided at the input of the first status memory 14 and simultaneously reaches the first multiplying element 19.

In this element, it is immediately multiplied by the value provided by the first coefficient memory 18. The product value provided at the output of the first multiplying element 19 is applied to the first input of the first adding element 22.

The current value of the uncompensated digital IF signal 9, stored in the first status memory 14, is directly available at the input of the second status memory 15 and simultaneously at the input of the second multiplying element 21.

In this element, it is immediately multiplied by the value provided by the second coefficient memory 20. The product value provided at the output of the second multiplying element 21 is applied to the second input of the first adding element 22 where the sum of the values of the first and the second input is computed directly. The sum supplied from the output of the first adding element 22 is applied to the first input of the second adding element 25.

Furthermore, the previous value of the uncompensated digital IF signal 9, stored in the second status memory 15, is directly available at the input of a further status memory 17 and simultaneously at the input of the third multiplying element 24.

In this element, it is immediately multiplied by the value provided by the third coefficient memory 23. The product value provided at the output of the third multiplying element 24 is applied to the second input of the second adding element 25 where the sum of the values of the first and the second input is computed directly. The sum supplied from the output of the second adding element 25 is applied to the first input of the further adding element 28.

Finally, the last value but two of the uncompensated digital IF signal 9, stored in the third status memory 17, is directly available at the input of the further multiplying element 27.

This value is immediately multiplied by the value provided by the further coefficient memory 26. The product value provided at the output of the further multiplying element 27 is applied to the second input of the further adding element 28 where the sum of the values of the first and the second input is computed directly. The sum supplied from the output of the further adding element 28 provides the instantaneously current value of the compensated digital IF signal 10 at the output of the digital compensation filter 4.

### LIST OF REFERENCE NUMERALS

1 BB/IF unit
2 BB/IF converter
3 digital BB processor signal
4 digital compensation filter
5 D/A converter
6 first smoothing bandpass filter
7 analog IF signal
8 RF transmission unit
9 uncompensated digital IF signal
10 compensated digital IF signal
11 W-LAN unit
12 antenna
13 second smoothing bandpass filter
14 first status memory
15 second status memory
17 further status memory
18 first coefficient memory
19 first multiplying element
20 second coefficient memory
21 second multiplying element
22 first adding element
23 third coefficient memory
24 third multiplying element
25 second adding element
26 further coefficient memory
27 further multiplying element
28 further adding element

1. A method of converting a digital BB (baseband) signal into an analog IF (intermediate-frequency) signal, wherein the digital BB processor signal is oversampled K times (K=number of channels) by means of a BB/IF converter, and each i^{th} channel of the K channels is subsequently selected by means of a controllable i^{th} digital interpolation filter comprised in the BB/IF converter and controllable in K steps and is shifted into the i^{th} frequency position in the spectrum of the analog IF signal, the frequency response of the D/A converter supplying the analog IF signal being corrected by pre-emphasis of the digital BB processor signal, characterized in that the frequency response of the digital BB processor signal is realized without pre-emphasis and in that, subsequent to the BB/IF converter supplying the uncompensated digital IF signal and prior to the D/A converter converting the signal into the analog IF signal a digital compensation filter corrects the frequency response for the analog IF signal by pre-emphasis of the compensated digital IF signal.

2. A method as claimed in claim 1, characterized in that the compensated digital IF signal is pre-emphasized in such a way that the filter characteristic of the digital compensation filter is formed complementarily to the frequency response of the D/A converter caused by the gap function (si).

3. A method as claimed in claim 2, characterized in that the compensated digital IF signal is pre-emphasized in such a way that the filter characteristic of the digital compensation filter is formed additionally complementarily to the frequency response caused by the transmission method used and the mode of modulation as well as by its parameter.

4. A method as claimed in claim 3, characterized in that the digital compensation filter is formed as a FIR filter, preferably with 1 to 5 delay elements.

5. A method as claimed in claim 3, characterized in that the digital compensation filter is preferably formed with binary weighted filter coefficients.
